(19) United States
(12) Patent Application Publication
(10) Pub. No.: US 2024/0383784 A1
(43) Pub. Date: Nov. 21, 2024

(54) ANTIMICROBIAL SYSTEM AND METHOD

(71) Applicant: KEMIRA OYJ, HELSINKI (FI)

(72) Inventors: Marko KOLARI, Espoo (FI); Jaakko SIMELL, Espoo (FI)

(21) Appl. No.: 18/722,120

(22) PCT Filed: Dec. 20, 2022
(86) PCT No.: PCT/EP2022/087037

§ 371 Date: Jun. 20, 2024

(30) Foreign Application Priority Data
Dec. 21, 2021 (GB) 2118671.3

(51) Int. Cl. C02F 1/50; C02F 1/76; C02F 103/28; D21F 1/66

(52) U.S. Cl. CPC C02F 1/50; C02F 1/76; D21F 1/66; C02F 2103/28; C02F 2307/14

(57) ABSTRACT

An antimicrobial system comprising (a) an antimicrobial compound according to Formula I (I) and (b) a stabilised chlorine compound, wherein the compounds are separate compounds or comprise a unitary composition; wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms; and wherein the stabilised chlorine compound comprises the reaction product of a reaction between active chlorine and a nitrogenous reactant selected from ammonium, urea, carbamate and dimethylhydantoin.

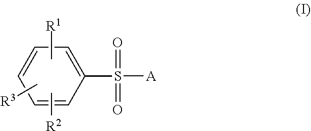

The present invention relates to a method for treating industrial process water, methods for reducing or preventing growth of microorganisms such as bacteria, and systems and compositions therefor.

### BACKGROUND TO THE INVENTION

Microorganisms such as bacteria can present a problem when apparatus or machinery, used for example in industrial processes, comes into contact with aqueous systems. Bacteria in water can exist in a free-floating form (sometimes known as planktonic) or can be in the form of a biofilm associated with surfaces. Biofilms in particular can be difficult to remove because they contain not only bacterial mass but also a protective sheath or film formed by the bacteria.

High levels of bacterial growth can be very problematic in industrial processes. Industrial process water used for example in the manufacture of pulp, paper and board is particularly susceptible to bacterial growth problems. These processes involve water containing microbial nutrients such as cellulose fibres and starch and are operated at temperatures enabling microorganisms to flourish. It is also common to recirculate the same process water several times in the manufacturing process. If left untreated, paper and board products may become defective and regular downtime for cleaning is required. It is therefore desirable to control microbe problems and this has been achieved by adding biocidal materials to the process waters.

Halogenated compounds have been shown to be effective biocides. Haloamines and chlorine dioxide are effective chemicals for microbe control on account of their ability to oxidise components of bacterial cells. They are relatively inexpensive and, at sufficiently high concentrations, can minimise both planktonic bacterial levels and prevent biofilm slime formation on system surfaces.

Although these biocides are effective, the presence of active halogen such as active chlorine has been found to give rise to corrosion problems on metal surfaces. In the paper industry, these problems have mainly arisen in the gas phase or at the interface of the water and gas phase. One solution to this problem is presented in EP2297046. Here, halogenated hydantoins were used in combination with haloamines. However, halogenated hydantoins are expensive and contain themselves active halogen which can still have some contribution to the problems of corrosion.

There therefore remains a need to provide effective control of microorganisms in industrial circulated water systems such as used in the manufacture of paper and board whilst simultaneously minimising the problems of corrosion.

### SUMMARY OF THE INVENTION

In a first aspect, the present invention provides an antimicrobial system comprising (a) an antimicrobial compound according to Formula I

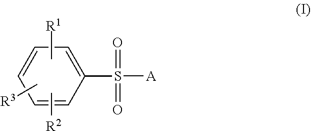

and
(b) a stabilised chlorine compound,
wherein the compounds are separate compounds or comprise a unitary composition;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms; and
wherein the stabilised chlorine compound comprises the reaction product of a reaction between active chlorine and a nitrogenous reactant selected from ammonium, urea, carbamate and dimethylhydantoin. The antimicrobial compound and the stabilised chlorine compound may be used separately, sequentially or simultaneously.

In a second aspect, the present invention provides a method for treating industrial process water, which method comprises administering to the water (i) an amount of an antimicrobial compound according to formula I

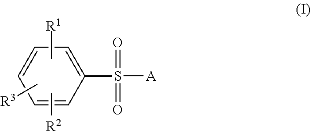

and
(ii) an amount of a stabilised chlorine compound;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms; and
wherein the stabilised chlorine compound comprises the reaction product of a reaction between active chlorine and a nitrogenous reactant selected from ammonium, urea, carbamate and dimethylhydantion. The antimicrobial compound and the stabilised chlorine compound may be administered separately, sequentially or simultaneously. The compounds may be administered to the water at the same location or at different locations within the same industrial process.

In accordance with the method for treating industrial process water, growth of microorganisms such as bacteria may be reduced or prevented. Such growth may be growth of free, planktonic microorganisms or those present in a structure such as a biofilm. This may arise by killing pre-existing microorganisms or stopping growth of new microorganisms. In this way, biofilm formation may also be reduced or prevented and pre-existing, formed biofilm may be reduced or removed, for example by dissolution of biofilm so that the microorganisms become planktonic and are subsequently killed.

It has surprisingly been found that a combination of the antimicrobial compound and the stabilised chlorine compound according to the invention provides effective activity against biofilms while simultaneously using only a low amount of stabilised chlorine compound. This means that, in use with industrial apparatus or equipment, the antimicrobial system produces reduced corrosion because less active chlorine is required. A safer working environment is also provided by the lower active chlorine production and inexpensive stabilised chlorine compounds can be effectively used.

Without wishing to be bound by theory, it is thought that the presence of the antimicrobial compound prevents biofilm formation and promotes biofilm dissolution. The stabilised chlorine compound is particularly effective against planktonic microorganisms even at low concentrations of the compound. Higher concentrations of the stabilised chlorine compound previously required to be effective against biofilms are not needed in the presence of the antimicrobial compound.

The antimicrobial compound has the structural Formula I. In this Formula, R1, R2 and R3 are independently substituents on the benzene ring at the ortho, meta and para positions.

Advantageously, R1 represents a methyl group; ethyl group; propyl group; butyl group; methoxy group; ethoxy group; propoxy group; isopropoxy group; n-butoxy group; or tertiary butoxy group; and/or
R2 and R3 represent independently hydrogen atom; methyl group; ethyl group; propyl group; butyl group; methoxy group; ethoxy group; propoxy group; isopropoxy group; n-butoxy group; tertiary butoxy group; and/or
A represents 2-propenenitrile.

Alternatively, R1 represents methyl group; ethyl group; propyl group; butyl group; methoxy group; ethoxy group; propoxy group; isopropoxy group; n-butoxy group; tertiary butoxy group; or amino group; and/or
R2 and R3 represent independently hydrogen atom; methyl group; ethyl group; propyl group; butyl group; methoxy group; ethoxy group; propoxy group; isopropoxy group; n-butoxy group; tertiary butoxy group; and/or
A represents a —CHCHCONR5R6 group, where R5 and R6 represent independently hydrogen atom; alkyl or hydroxyalkyl having 1 to 4 carbon atoms; preferably R5 and R6 representing hydrogen atoms.

Preferably, the compound according to Formula I is selected from the group consisting of 3-[(4-methylphenyl)sulphonyl]-2-propenenitrile, 3-phenylsulphonyl-2-propenenitrile, 3-[(4-fluorophenyl)sulphonyl]-2-propenenitrile, 3-[(4-trifluormethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4,6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers. Of these compounds it is more preferred that the compound according to Formula I is selected from the group consisting of 3-[(4-methylphenyl)sulphonyl]-2-propenenitrile, 3-phenylsulphonyl-2-propenenitrile, 3-[(4-trifluormethylphenyl)sulphonyl]-2-propenenitrile, 3-[(2,4,6-trimethylphenyl)sulphonyl]-2-propenenitrile, 3-(4-methoxyphenyl)sulphonyl-2-propenenitrile and 3-[(4-methylphenyl)sulphonyl]prop-2-enamide; and any of their isomers. It is particularly preferred that the compound is 3-[(4-methylphenyl)sulphonyl]-2-propenenitrile.

Antimicrobial compounds suitable for use in the present invention and their synthesis are also described in WO2019/042984A and WO2019/042985A.

The stabilised chlorine compound comprises the reaction product of a reaction between active chlorine and a nitrogenous reactant selected from ammonium, urea and dimethylhydantoin. The reaction is well known and is typically performed in situ so that the stabilised chlorine compound is freshly prepared for use. This is because stabilised chlorine solutions have limited storage stability.

Ammonium is typically supplied in salt form and is the preferred nitrogenous reactant. Preferred ammonium salts are ammonium sulphate, ammonium bromide, ammonium carbamate and ammonium chloride. Chlorine is typically supplied in the form of an active chlorine source such as a hypochlorite. A preferred active chlorine source is sodium hypochlorite.

The reaction is usually carried out simply by mixing the reactants together in the presence of dilution water. For ammonium and urea, mixing with chlorine at too high concentrations can lead to deterioration of the stabilised chlorine compound in solution. It is therefore preferred that there is a dilution of the reactants, so that the formed stabilised chlorine compound product has an active chlorine concentration of 500 to 10,000 mg/l. It is preferred that the molar ratio of active chlorine to nitrogen is approximately 1:1 because the nearer to an equimolar ratio the more stable the stabilised chlorine solution is. It is also preferred that mixing is performed under alkaline conditions. For example, mixing of ammonium and hypochlorite will form monochloramine (MCA). At 1 to 1 molar ratio (active chlorine to nitrogen), dilution by water to final active chlorine concentration of 5.000 mg/l at pH of 9.0 yields a stabilized chlorine solution where monochloramine remains stable for over an hour. However, mixing with higher active chlorine to nitrogen ratio and at a pH below 7 could lead to formation of e.g. unwanted dichloramines and also impact the stability of the stabilized chlorine solution.

A stabilised chlorine compound made from dimethylhydantoin typically involves a reaction with sodium hypochlorite (see U.S. Pat. No. 6,429,181). In this way, monochloro-5,5-dimethylhydantoin (MCDMH) may be formed. This reaction is also carried out by mixing. However, dilution water is not necessary. For example, it is possible to mix 15% hypochlorite and 15% dimethylhydantoin (in water) directly. The mixing ratio is also unimportant. If active chlorine is supplied in excess, the amount of monochloro-5,5-dimethylhydantoin is simply limited to the amount of available dimethylhydantoin. Any excess active chlorine will just remain as free active chlorine without stabilisation. Dimethylhydantoin is the least preferred nitrogenous reactant because it is relatively expensive.

A particularly useful combination of antimicrobial compound and stabilised chlorine compound is 3-[(4-methylphenyl)sulphonyl]-2-propenenitrile and MCA (monochloramine).

The method of the invention is applicable to a variety of industrial processes. Many of these processes use process water which contains components which provide nutrition to microorganisms. In addition, many industrial processes operate at elevated temperature, such as at least 40° C. or at least 50° C., which can also promote the growth of microorganisms. The microorganisms present in the water may grow in biofilms and cause biofouling and biocorrosion, also known as microbiologically influenced corrosion (MIC). Microbial biofilms may reduce conductive heat transfer across surfaces and may clog hydraulic systems with consequent energy losses and possible production cutbacks and shutdowns.

Typical bacteria found in industrial process water include Meiothermus, Deinococcus and/or Pseudoxanthomonas. MIC can also be caused by e.g., Sulphate-reducing bacteria (SRB), sulphate-reducing Archae (SRA), acid-producing bacteria, methanogens or iron-oxidizing bacteria. Proteobacteria are the dominant microbial group found from cooling water biofilms.

The industrial process water to be treated relates to water from any apparatus or equipment used in any industry and includes industrial circulating water. Included is water used in industrial manufacturing processes, water used as cooling water which may be circulated through pipework, and water used in the oil and gas industry. Examples of waters in oil and gas industry requiring control of microorganisms are injection waters, fracturing fluids, tankage, pipelines and hydrostatic test waters.

Alternatively, or in addition, the antimicrobial system of the invention may be added to cooling water systems which may be in a separate circuit from the industrial manufacturing process. Typically, such cooling water systems comprise circulating water which contacts with a heat exchanger that is in contact with process water or apparatus from the industrial manufacturing process. Cooling water systems can operate at a wide range of temperatures depending on the temperature of the water supply and the temperature at which the industrial process or apparatus to be cooled. Temperatures in the range 5° C. to 50° C. or more are found. Many such systems operate at elevated temperature, such as at least 30° C.

Industrial manufacturing processes comprising fibre material, such as manufacture of paper, board, pulp, tissue, moulded pulp, non-woven, viscose or the like are particularly suitable for treatment according to the invention. The industrial process water comprises preferably at least water, cellulosic fibre material, fines and/or fibre fragments of natural origin. The process water may also comprise starch. The cellulosic fibre material typically originates from softwood, hardwood or non-wood sources, such as bamboo, straw or kenaf, or any mixtures thereof. Preferably the cellulosic fibre material originates from lignocellulosic fibre material. More preferably the cellulosic fibre material is lignocellulosic fibres. The cellulosic fibre material may originate from any suitable mechanical, chemi-mechanical or chemical pulping process or any of their combinations or any other suitable pulping process known as such. The cellulosic fibre material may also comprise fibre material which originates from recycled board, paper or pulp. For example, the cellulosic fibre material may comprise cellulosic fibres that originate from hardwood and have a length of 0.5-1.5 mm and/or from softwood and have a length of 2.5-7.5 mm. The process water may also comprise inorganic mineral particles, such as fillers and/or coating minerals; hemicelluloses; lignin; and/or dissolved and colloidal substances. The process water may also comprise papermaking additives, such as starch, sizing agents, inorganic or organic coagulation or flocculation agents, natural or synthetic polymers of different length and/or charge, dyes, optical brighteners or any combination thereof.

In one arrangement, the industrial manufacturing process has process water comprising cellulosic fibre material of natural origin and is pulp and/or paper and/or board manufacturing process, where the process water shows high temperature and/or high flow rate. The antimicrobial system according to the invention is thus added or dosed to a pulp and/or paper and/or board manufacturing system. The water in these processes often shows high flow and high shear rates, which may induce the formation of biofilm on the process surfaces due to the stress of microorganisms. For example, in paper and board making environments the flow rates may typically be higher than 1 m/s, even over 10 m/s, typically from 1 to 20 m/s or from 1 to 10 m/s. It has been observed that the antimicrobial system according to the invention is effective especially in these demanding conditions, and it may be generally used throughout the whole process in order to reduce and/or to prevent the growth of microorganisms and the formation of biofilm on the process surfaces.

The industrial manufacturing process comprising cellulosic fibre material of natural origin may be a pulp and/or paper and/or board manufacturing process, where the pH of the aqueous environment is in the range 5-9, preferably 7-8.5.

In one arrangement of the present invention the antimicrobial system of the invention may be added in the industrial manufacturing process having process water comprising cellulosic fibre material, which is a paper and/or board manufacturing process, especially in a short loop of the paper or board making process. In a typical paper and board making process, pulp stock is passed into a headbox, which distributes the pulp stock onto a moving wire in a forming section, on which the continuous paper web is formed. The short loop or short circulation section of a paper/board machine is here understood, as customary in the art, the part of the manufacturing system that re-circulates and recycles at least a part of excess water from the pulp stock, collected in a wire pit in the forming section, back to the headbox for re-use.

Alternatively, or in addition, the antimicrobial system of the invention may be added in the industrial manufacturing process having process water comprising cellulosic fibre material, e.g. pulp and/or paper and/or board manufacturing process, to process water in any location of the process, such as circulating water tank, circulating water tower, filtrate water towers; to clear or cloudy filtrate storage tanks; pulpers; aqueous streams upstream/downstream of the pulpers; broke system and aqueous process streams upstream/downstream of vessels therein; wire pit process streams upstream/downstream of the pit; paper machine blend chest process streams upstream/downstream of the chest; fresh water tank; warm water tank and/or shower water tank.

Alternatively, or in addition, the antimicrobial system of the invention may be added in the industrial manufacturing process having process water comprising cellulosic fibre material, which is paper and/or board manufacturing process, to any location in a long loop of the paper or board making process. The long loop or long circulation section of a paper/board machine is here understood, as customary in the art, the part of the manufacturing system that handles excess water and broke. A major part of the recovered water exits the short loop and is pumped to the long loop, which includes: save-all for capturing useful fibres from the recovered water for reuse, storage tanks for filtrate water used for example in machine showers, and storage tanks for recirculated water used for example as dilution water for importing pulp from pulp mill to paper/board machine. A part of the long loop is the broke system for handling of wet and dry paper rejects from the machine. This material is repulped and reused as a part of the pulp stock.

The antimicrobial compound and the stabilised chlorine compound may be added to the process water as a solid, such as dry powder, or more preferably in a liquid form. Compounds may be dosed continuously or periodically. According to one arrangement one or both compounds may be administered periodically in process water for 3-45 minutes for 6-24 times a day, preferably for 10-30 minutes for 12-24 times a day.

The antimicrobial compound and the stabilised chlorine compound may be added as a unitary composition although more typically they are added separately or sequentially. They may be added simultaneously, either as a unitary composition or at the same time as separate components. Alternatively, they may be added sequentially as separate components. Addition as separate components may made at the same location in the process water or at different locations. However the components are added, it is necessary for both to be administered to the process water for the combined effect to be realised.

The antimicrobial compound may be administered batchwise or continuously to the process. Preferably it is dosed continuously, in one to three dosing points in the process, in a manner so that the compound reaches all parts of the process which are prone to biofilm formation. These parts include blend chest, short loop, headbox, wire pit, circulating water tank or tower, save all, filtrate water tank or tower, fresh water tank, warm water tank and/or shower water tank, preferably the short loop, circulating water tank or tower, filtrate water tank or tower and/or shower water tank.

The stabilized chlorine may be administered batchwise or continuously to the process. Preferably it is dosed to several dosing points in the system, especially to locations that are less susceptible to corrosion, preferably avoiding the short loop and headbox. These locations include pulper, pulp tank or tower, blend chest, machine chest, circulating water tank or tower, filtrate water tank or tower, fresh water tank, warm water tank and/or shower water tank, save all, recovered fiber tank, broke pulper, wet broke tank or tower and/or dry broke tank or tower, preferably the blend chest, machine chest, circulating water tank or tower, filtrate water tank or tower, broke pulper, wet broke tank or tower and/or dry broke tank or tower.

Both compounds may be administered batchwise to the process, both compounds may be administered continuously to the process, or one compound may be administered batchwise and the other continuously.

In principle, the compounds may be added at almost any point in the process, especially into recirculated process water to maintain the control of microorganisms and/or biofilm formation throughout the process. The compounds may also or alternatively be added to raw material flow. For example, one or both compounds may be added to cellulosic fibre material, e.g. lignocellulosic fibre material, which is used as a raw material in the process.

Corrosion is a concern in these industrial settings, such as in a paper machine, where many grades of steel are susceptible to the action of active chlorine or other halogens in the gas phase or at the interface between the aqueous phase and gas phase. Halogen-promoted electrochemical processes can also contribute to corrosion at the interface. Many components of a paper machine which are above water surface level are formed of milder steel materials. Such corrosion is a particular problem in the short loop. In accordance with the present invention these problems are minimised. This is because the amounts of stabilised chlorine compound administered can be kept to a minimum owing to the presence of the antimicrobial compound.

The stabilised chlorine compound may be administered to provide an amount in the range of from 0.1 to 5 ppm, preferably from 0.1 to 2 ppm and more preferably from 0.1 to 1 ppm calculated as active chlorine and based on the volume of water. Typically, the amounts administered to the process water may be calculated, based on the volume of water in the system and, for continuous administration, the flow rate of the stabilised chlorine compound into the water. The calculated amounts should correspond to measured amounts in the process water where the supply of water is clean. Where the process water supply contains substances, such as organic matter or chemical compounds, in quantities which will initially consume active chlorine from the stabilised chlorine compound, the calculated amounts will not correspond to measured amounts in the process water. Here, higher amounts of the stabilised chlorine compound would need to be used to achieve the amounts calculated above as active chlorine, based on the volume of the water.

The amount of antimicrobial compound administered is in the range of from 0.01 to 100 ppm, from 0.01 to 50 ppm, from 0.01 to 40 ppm or from 0,01 to 20 ppm, preferably 0.01 to 10 ppm, more preferably 0.01 to 2 ppm, calculated as active compound and based on the volume of the water. Preferably, the amount of antimicrobial compound administered is in the range of from 0.01 to 1 ppm, preferably 0.01 to 0.5 ppm, more preferably 0.01 to 0.3 ppm, still more preferably 0.05 to 0.2 ppm, calculated as active compound and based on the volume of the water.

In general, the antimicrobial system according to the invention may be added to the process water in biostatic or biocidal amounts. Biostatic amount refers to an amount sufficient to at least prevent and/or inhibit the activity and/or growth of the microorganisms or the biofilm. Biocidal amount refers to more effective activity, such as to an amount capable of reducing the activity and/or growth of the microorganisms or the biofilm and/or killing most or all of the microorganisms present in the process water.

The invention further provides use of an antimicrobial system as defined above for treating industrial process water, such as industrial circulating water.

The invention further provides use of an antimicrobial system as defined above for reducing or preventing growth of microorganisms in industrial process water.

The present invention further provides use of an antimicrobial system as defined above for reducing or preventing biofilm formation and/or reducing or removing formed biofilm.

The present invention further provides a method for reducing or preventing growth of microorganisms, preferably bacteria, in industrial process water.

The present invention further provides a method for reducing or preventing biofilm formation and/or reducing or removing formed biofilm in industrial process water.

### DETAILED DESCRIPTION OF THE INVENTION

This invention will now be described in more detail, by way of example only, with reference to the accompanying Figures, in which:

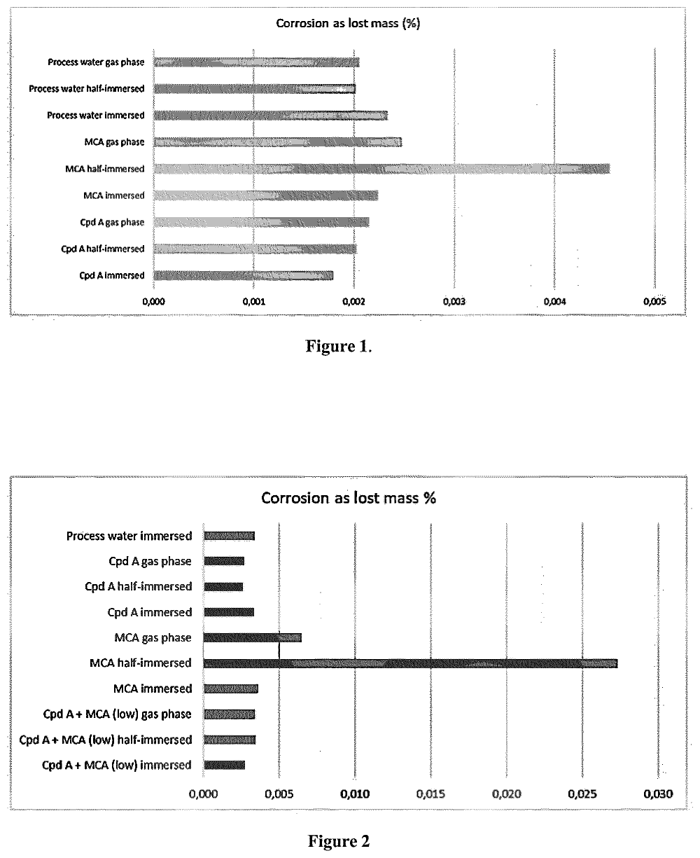

FIG. 1 is a bar chart showing corrosion effects of chemical compounds used in the present invention; and

FIG. 2 is a further bar chart showing corrosion effects of chemical compounds used in the present invention.

The term “comprises” as used throughout the description and claims herein means “includes or consists of”. The term denotes the inclusion of at least the features following the term and does not exclude the inclusion of other features which have not been explicitly mentioned. The term may also denote an entity which consists only of the features following the term.

### EXPERIMENTAL PROCEDURES

### Materials and Methods

Pure cultures of Meiothermus silvanus, a microbe species commonly found in paper machine biofilms (Ekman J, Journal of Industrial Microbiology & Biotechnology 34:203-211) and Pseudoxanthomonas taiwanensis, another species commonly found in paper machine environments (Desjardins, E & Beaulieu, C, Journal of Industrial Microbiology & Biotechnology 30:141-145) were used to study the efficacy of various chemicals to prevent biofilm formation.

Biofilm tests were done in fibre-containing synthetic paper machine water, SPW (prepared according to Peltola, et al., J. Ind. Microbiol. Biotechnol. 38: 1719-1727) using 96-microwell plate wells with peg lids (Thermo Fischer Scientific Inc., USA). Plates were incubated at 45° C. with a rotary shaking (150 rpm) providing high flow in each well.

3-[(4-methylphenyl)sulphonyl]-2-propenenitrile, hereinafter called Compound A: manufactured by Kemira; purity>98% E-isomer.

2,2-dibromo-3-nitrilopropionamide, hereinafter called DBNPA, was obtained from Kemira Oyj (Fennosan R20, 20% active ingredient).

Sodium hypochlorite solution was obtained from Kemira Oyj (15% active ingredient). Since the active Chlorine decomposes over time, the amount of active Chlorine in the solution was measured prior to each experiment.

Monochloramine (MCA) was freshly prepared by adding first dilution water to the bottle and then sodium hypochlorite solution with known amount of active Chlorine. After mixing, equimolar dilute ammonium sulphate solution was added so as to produce aqueous MCA with 1.0% active chlorine.

### Biofilm Tests

Wells of 96-microwell plates with peg-lids were filled with SPW and inoculated with the pure bacterial cultures. Biofilm was grown at 45° C. with a rotary shaking (150 rpm) for 24 hours without addition of any chemical compound to be tested.

After 24 hours from starting the test, the wells were emptied and a fresh solution of SPW, inoculated with the pure bacterial cultures and with different amounts of chemical compounds to be tested were added and the original peg-lid was placed back in place. After an additional 24 hours the wells were emptied and the biofilm amount on the pegs was quantified.

### Quantification of Formed Biofilm

The amount of biofilm formed on the peg surfaces was quantified with a staining solution by adding 200 μl of 1% Crystal Violet (Merck Millipore KGaA, Germany) in methanol to each well in a clean 96-well plate and placing the biofilm-containing peg-lid on it. After 3 minutes the wells were emptied and the wells and pegs were rinsed 3 times with tap water. Finally the peg-lid was placed in a clean 96-well plate, the attached Crystal Violet was dissolved into ethanol and the absorbance at 595 nm was measured.

All parts per million (ppm) amounts given in Examples 1-2 are as active ingredients. The Impact values are calculated as biofilm reduction percentages based on a comparison with no added chemicals. A positive value indicates a reduction in amount of biofilm whereas a negative value indicates an increase in the amount of biofilm.

Table 1 shows the effect of sodium hypochlorite dosing in the presence and absence of Compound A on Meiothermus silvanus biofilms in SPW at 45° C. and 150 rpm (high mixing). Biofilm was stained and quantified by absorbance measurement. Dosages are given as active ingredients.

TABLE 1

| Sodium hypochlorite | Compound A | |
|---|---|---|
| ppm | ppm | Impact |
| 2 | | −71% |
| 4 | | 1% |
| 8 | | 5% |
| | 0.15 | 7% |
| | 0.3 | −7% |
| 2 | 0.15 | −10% |
| 4 | 0.15 | 26% |
| 8 | 0.15 | 49% |

Table 2 shows the effect of sodium hypochlorite dosing in the presence and absence of Compound A on Pseudoxanthomonas taiwanensis biofilms in SPW at 45° C. and 150 rpm (high mixing). Biofilm was stained and quantified by absorbance measurement. Dosages are given as active ingredients.

TABLE 2

| Sodium hypochlorite | Compound A | |
|---|---|---|
| ppm | ppm | Impact |
| 4 | | −3% |
| 8 | | −5% |
| 16 | | 0% |
| | 0.15 | 5% |
| | 0.3 | 7% |
| 4 | 0.15 | 8% |
| 4 | 0.3 | 11% |
| 8 | 0.15 | 21% |
| 8 | 0.3 | 27% |

Tables 1 and 2 demonstrate the ability of Chlorine-containing biocide sodium hypochlorite to reduce and prevent biofilm formation of Meiothermus silvanus and Pseudoxanthomonas taiwanensis respectively, in the presence and absence of Compound A. Test conditions simulated paper or board making process conditions (synthetic paper machine water, high temperature, fibres present, high flow). The Chlorine-containing biocide sodium hypochlorite was ineffective on its own in reaching acceptable biofilm reduction efficacy even up to a dosage of 8 or 16 ppm. Sodium hypochlorite required a dosage of 4 or 8 ppm active compound in the presence of Compound A to reach acceptable or noticeable biofilm reduction efficacy.

### EXAMPLE 2

Table 3 shows the effect of MCA dosing in the presence and absence of Compound A on Meiothermus silvanus biofilms in SPW at 45° C. and 150 rpm (high mixing). Biofilm was stained and quantified by absorbance measurement. Dosages are given as active ingredients.

TABLE 3

| MCA | Compound A | |
|---|---|---|
| ppm | ppm | Impact |
| 0.5 | | −22% |
| 1 | | 4% |
| 1.5 | | −2% |
| | 0.3 | −15% |
| | 0.45 | 11% |
| 0.5 | 0.3 | 17% |
| 1 | 0.15 | 22% |
| 1 | 0.3 | 26% |

Table 4 shows the effect of MCA dosing in the presence and absence of Compound A on Pseudoxanthomonas taiwanensis biofilms in SPW at 45° C. and 150 rpm (high mixing). Biofilm was stained and quantified by absorbance measurement. Dosages are given as active ingredients.

TABLE 4

| MCA | Compound A | |
|---|---|---|
| ppm | ppm | Impact |
| 0.5 | | −11% |
| 1 | | −3% |
| 1.5 | | 7% |
| | 0.15 | 19% |
| 0.5 | 0.3 | 26% |
| 1 | 0.15 | 43% |

Tables 3 and 4 demonstrate the ability of stabilised chlorine compound MCA to reduce and prevent biofilm formation of Meiothermus silvanus and Pseudoxanthomonas taiwanensis respectively, in the presence and absence of Compound A. Test conditions simulated paper or board making process conditions (synthetic paper machine water, high temperature, fibres present, high flow). The stabilised chlorine compound MCA was ineffective on its own in reaching acceptable biofilm reduction efficacy at low dosages. Likewise, Compound A also was ineffective on its own in reaching acceptable biofilm reduction efficacy at low dosages. However, in the presence of Compound A, MCA required a dosage of only 0.5 or 1 ppm active compound to reach significant biofilm reduction efficacy. This result indicates that the combination of Compound A and MCA can be used at low dosages for effective anti-biofilm efficacy.

The results on anti-biofilm efficacy are surprising and important. At relatively low concentrations, a compound such as sodium hypochlorite is ineffective against biofilms. The presence of the benzenesulphonyl compound, Compound A, increases the effectiveness of this biocide compound but not significantly enough to be highly effective in SPW. Should higher concentrations of hypochlorite be contemplated, it would be expected that the presence of much higher levels of active halogen would have highly corrosive effects on industrial apparatus. At low concentrations, Compound A was also ineffective as an anti-biofilm agent. However, surprisingly, a combination of low concentrations of MCA together with low concentrations of Compound A were effective against biofilm. Because only low amounts of active chlorine need be used, this is important in biofilm control in industrial processes because the levels of corrosion mediated by active chlorine will be significantly reduced. Similar effects may be obtained from stabilised chlorine compounds other than MCA and benzenesulphonyl compounds of Formula (I) other than Compound A.

### EXAMPLE 3 (CORROSION TESTING)

In this example, anti-microbial compounds and stabilised chlorine compounds are subjected to corrosion testing.

Corrosion testing was performed following ASTM G31-72. Glass reactors of 2 L in volume equipped with reflux condensers were used at atmospheric pressure. The reactors were immersed in a water bath at a temperature of 55° C. 1.5 L of white water from an alkaline fine paper machine was added to each reactor. Tests were performed in duplicate over a period of seven days with no stirring in the reactors. The tests were carried out with samples of Compound A, MCA and a reference containing white water only. Two stainless steel grades: AISI 304 and AISI 316L were used in the tests.

Before the test, coupons of the appropriate steel grade were ground to remove passivation film from the metal surface. After grinding, the coupon surfaces were cleaned with ethanol in an ultrasonic bath for 10 minutes and finally degreased and dried with acetone. The coupons were weighed and used on the same day.

After completion of the tests, the coupons were washed with a brush using washing detergent and hot water. They were then flushed with deionised water and pickled in 5% HCl in an ultrasonic bath for 10 minutes.

According to the test method, corrosion is calculated as mass loss of uniform corrosion.

For each chemical to be tested, three test coupons were placed in each reactor: one completely immersed into the liquid phase, one half immersed in the liquid phase and one in the gas phase. The chemicals to be tested were dosed in water to a final concentration of 0.08 ppm of Compound A and 4 ppm of MCA as total active chlorine. Chemicals were added at the start and re-dosed during the study once or twice per day. In total, Compound A was dosed six times and MCA dosed nine times. The aim of the dosages was to match realistic use conditions, i.e. shock dosages resulting in fluctuating levels of chemicals in the process water.

### Results

In the high-quality steel 316L grade no corrosion was observed in any of the samples over the test time of seven days.

In the 304 grade, mild corrosion was observed with one treatment only. In the MCA treated reactors those coupons that were half immersed showed mild corrosion. However, there was no corrosion in any of the Compound A treated reactors or in the untreated reference. These results are summarised in the bar chart in FIG. 1. This shows the mean of the results from duplicate reactors run for 7 days at 55° C.

### EXAMPLE 4 (CORROSION TESTING)

In this example, the studies set out in Example 3 continued with stainless steel grade 304. Using the same setup as in Example 3, with fresh process water from a paper mill, chemical concentrations were increased tenfold. Although such high dosages were far greater than realistic dosages in industrial practice, the higher dosages were used to simulate a longer period of contact with the chemicals where increased corrosion would be expected.

In these tests combinations of Compound A and MCA were also tested at realistic low dosage levels of 0.08 ppm of Compound A and 4 ppm of MCA as total active chlorine.

### Results

The results are shown in FIG. 2. This shows the mean of the results from duplicate reactors run for 7 days at 55° C.

In all reactors treated with Compound A, the corrosion rates of the steel coupons were similarly as low as in reactors with process water only. A tenfold increase in the concentration of MCA caused increased corrosion. In the MCA treated reactors, those coupons that were half immersed showed 10.5 times higher corrosion than half immersed coupons in Compound A treated reactors. In the MCA treated reactors, those coupons that were in the gas phase showed 2.5 times higher corrosion than gas phase coupons in Compound A treated reactors. The higher levels of corrosion in the half immersed coupons are ascribable to electrochemical process at the gas-liquid interface.

The combination of a low MCA dose with Compound A showed similarly low corrosion rates compared with the process water only.

These results suggest that levels of a stabilised chlorine compound (such as MCA) and a benzenesulphonyl antimicrobial compound (such as Compound A) which are efficacious for biofilm treatment do not cause significant corrosion of the type of stainless steel used in industrial apparatus.

1. An antimicrobial system comprising (a) an antimicrobial compound according to Formula I 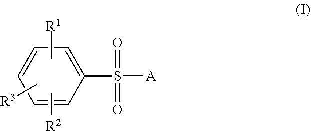
and
(b) a stabilised chlorine compound,
wherein the compounds are separate compounds or comprise a unitary composition;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms; and
wherein the stabilised chlorine compound comprises the reaction product of a reaction between active chlorine and a nitrogenous reactant selected from ammonium, urea and dimethylhydantoin.

2. A system according to claim 1, wherein in Formula (I)
R1 represents methyl group; ethyl group; propyl group; butyl group; methoxy group; ethoxy group; propoxy group; isopropoxy group; n-butoxy group; or tertiary butoxy group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents 2-propenenitrile.

3. A system according to claim 1, wherein in Formula (I)
R1 represents methyl group; ethyl group; propyl group; butyl group; methoxy group; ethoxy group; propoxy group; isopropoxy group; n-butoxy group; tertiary butoxy group; or amino group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents a —CHCHCONR5R6 group, where R5 and R6 represent independently hydrogen atom; alkyl or hydroxyalkyl having 1 to 4 carbon atoms; preferably R5 and R6 representing hydrogen atoms.

4. A system according to claim 1, wherein the compound according to Formula (I) is selected from group consisting of 3-[(4-methylphenyl)sulphonyl]-2-propenenitrile, 3-phenylsulphonyl-2-propenenitrile, 3-[(4-fluorophenyl)sulphonyl]-2-propenenitrile, 3-[(4-trifluormethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4,6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers.

5. A system according to claim 4, wherein the compound according to Formula (I) is selected from group consisting of 3-[(4-methylphenyl)sulphonyl]-2-propenenitrile, 3-phenylsulphonyl-2-propenenitrile, 3-[(4-trifluormethylphenyl)sulphonyl]-2-propenenitrile, 3-[(2,4,6-trimethylphenyl)sulphonyl]-2-propenenitrile, 3-(4-methoxyphenyl)sulphonyl-2-propenenitrile and 3-[(4-methylphenyl)sulphonyl]prop-2-enamide; and any of their isomers, wherein the compound is preferably 3-[(4-methylphenyl)sulphonyl]-2-propenenitrile.

6. A system according to claim 1, wherein the stabilised chlorine compound comprises the reaction product of a reaction between an active chlorine source and a nitrogenous reactant selected from an ammonium salt and urea.

7. A system according to claim 6, wherein the stabilised chlorine compound comprises monochloramine.

8. A method for treating industrial process water, which method comprises administering to the water (i) an amount of an antimicrobial compound according to formula I 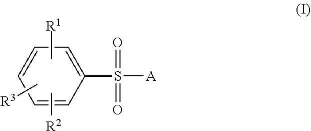
and
(ii) an amount of a stabilised chlorine compound;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms; and
wherein the stabilised chlorine compound comprises the reaction product of a reaction between chlorine and a nitrogenous reactant selected from ammonium, urea and dimethylhydantoin.

9. A method according to claim 8, which comprises reducing or preventing growth of microorganisms, preferably bacteria.

10. A method according to claim 9, which comprises reducing or preventing biofilm formation and/or reducing or removing formed biofilm.

11. A method according to claim 9, wherein the microorganisms are bacteria belonging to genus of Meiothermus, Deinococcus and/or Pseudoxanthomonas.

12. A method according to claim 8, wherein the industrial process water comprises cooling water or water comprising fibre material.

13. A method according to claim 12, wherein the water comprises cellulosic fibre material and is circulated in contact with apparatus for manufacturing paper, board, pulp, tissue, moulded pulp, non-woven or viscose, preferably apparatus for manufacturing pulp, paper or board.

14. A method according to of claim 8, wherein the temperature of the water is at least 40° C., preferably at least 50° C.

15. A method according to claim 8, wherein the amount of antimicrobial compound administered is in the range of from 0.01 to 100 ppm, preferably 0.01 to 10 ppm, more preferably 0.01 to 2 ppm, calculated as active compound and based on the volume of the water.

16. A method according to claim 15, wherein the amount of antimicrobial compound administered is in the range of from 0.01 to 1 ppm, preferably 0.01 to 0.5 ppm, more preferably 0.05 to 0.2 ppm, calculated as active compound and based on the volume of the water.

17. A method according to claim 8, wherein the amount of stabilised chlorine compound administered to the water provides a range of from 0.1 to 5 ppm, preferably 0.1 to 2 ppm, more preferably 0.1 to 1 ppm calculated as active chlorine and based on the volume of the water.

18. A method according to claim 8, wherein the antimicrobial compound is administered continuously to the water.

19. A method according to claim 8, wherein each compound is added at a different location of the industrial process water.

20. A method according to claim 8, wherein the stabilised chlorine compound is administered to an apparatus for manufacturing pulp, paper or board, at a location avoiding the short loop and headbox.

21. A method according to claim 8, wherein:
(a) in Formula (I)
R1 represents methyl group; ethyl group; propyl group; butyl group; methoxy group; ethoxy group; propoxy group; isopropoxy group; n-butoxy group; or tertiary butoxy group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents 2-propenenitrile; or
(b) in Formula (I)
R1 represents methyl group; ethyl group; propyl group; butyl group; methoxy group; ethoxy group; propoxy group; isopropoxy group; n-butoxy group; tertiary butoxy group; or amino group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents a —CHCHCONR5R6 group, where R5 and R6 represent independently hydrogen atom; alkyl or hydroxyalkyl having 1 to 4 carbon atoms; preferably R5 and R6 representing hydrogen atoms.

22. A method according to claim 8, wherein the compound according to Formula (I) is selected from group consisting of 3-[(4-methylphenyl)sulphonyl]-2-propenenitrile, 3-phenylsulphonyl-2-propenenitrile, 3-[(4-fluorophenyl)sulphonyl]-2-propenenitrile, 3-[(4-trifluormethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4,6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers.

23. A method according to claim 8, wherein the stabilised chlorine compound comprises the reaction product of a reaction between an active chlorine source and a nitrogenous reactant selected from an ammonium salt and urea, optionally wherein the stabilised chlorine compound comprises monochloramine.

24. A method for treating industrial process water, which method comprises administering to the water: (i) an amount of an antimicrobial compound selected from the group consisting of 3-[(4-methylphenyl)sulphonyl]-2-propenenitrile, 3-phenylsulphonyl-2-propenenitrile, 3-[(4-trifluormethylphenyl)sulphonyl]-2-propenenitrile, 3-[(2,4,6-trimethylphenyl)sulphonyl]-2-propenenitrile, 3-(4-methoxyphenyl)sulphonyl-2-propenenitrile and 3-[(4-methylphenyl)sulphonyl]prop-2-enamide, and any of their isomers; and (ii) an amount of monochloramine.
